(19) United States
(12) Patent Application Publication
(10) Pub. No.: US 2024/0183344 A1
(43) Pub. Date: Jun. 6, 2024

(54) Efficient five-cylinder drilling pump system, solids control system and drilling rig

(71) Applicant: SICHUAN HONGHUA PETROLEUM EQUIPMENT CO., LTD, Guanghan,Sichuan (CN)

(72) Inventors: Fangfang Zhang, Guanghan,Sichuan (CN); Junqing Chai, Guanghan,Sichuan (CN); Jian Cheng, Guanghan,Sichuan (CN); Mingpeng Tang, Guanghan,Sichuan (CN); Hui Zeng, Guanghan,Sichuan (CN)

(21) Appl. No.: 18/286,361

(22) PCT Filed: Jan. 25, 2022
(86) PCT No.: PCT/CN2022/073705

§ 371 Date: Oct. 10, 2023

(30) Foreign Application Priority Data
Jun. 29, 2021 (CN) 202110726735.2

(51) Int. Cl. F04B 1/34; E21B 43/12; F04B 53/16; F04B 53/18

(52) U.S. Cl. CPC F04B 1/34; E21B 43/121; F04B 53/162; F04B 53/18; F04B 2201/0801; F04B 2205/06

(57) ABSTRACT

An efficient five-cylinder drilling pump system, includes a solid control system and a drilling rig provided, belonging to the technical field of petroleum drilling equipment; wherein the system includes a drilling pump group, a frequency conversion control room and a pump health system; the drilling pump group includes a base, the base is provided with a transmission assembly, a power end assembly, a hydraulic end assembly and a lubrication system; the frequency conversion control room is used to provide frequency-changing AC power for the transmission assembly, and realize the control and operation of the drilling pump group, the pump health system includes a power end health diagnosis system and a hydraulic end health diagnosis system; a high-power five-cylinder drilling pump system, a solids control system and a drilling rig of the present invention can monitor the pumping equipment in real time, and use electronic monitoring to monitor the pumping equipment in real time. Track pump performance parameters, display pump health status in real time, provide predictive pump inspection instructions, reduce unpredicted equipment downtime, improve equipment stability and reduce overall maintenance costs.

### BACKGROUND OF THE PRESENT INVENTION

### Field of Invention

The present invention relates to an efficient five-cylinder drilling pump system, a solids control system and a drilling rig, which belongs to the technical filed of petroleum drilling devices.

### Description of Related Arts

At present, new drilling technologies such as deep or ultra-deep wells, high pressure jet drilling, extended-reach horizontal wellscluster wells, and offshore platforms require drilling pumps to develop in the direction of high power, large displacement, high pump pressure, high reliability and light weight. At present, the conventional drilling pump is powered by a diesel engine, and then the power is distributed through the parallel box or the chain box, and finally the belt or chain that drives the mud pump group realizes the power transmission. The long transmission chain has low transmission efficiency, heavy equipment operation and maintenance workload, and large floor space, making it difficult to adapt to the increasingly high technical requirements of drilling technology. In view of this construction situation, the oilfield hopes to design and manufacture a drilling pump system with small footprint, high efficiency and high power to solve the production problem of the oilfield.

### SUMMARY OF THE PRESENT INVENTION

An object of the present invention is to provide a high-power five-cylinder drilling pump system, a solids control system and a drilling rig in view of the above-mentioned problems. Compared with the traditional structure, the device has the advantages of simple structure, compact structure and efficient detection effect.

Technical solutions that the present invention adopt are as follows.

A high-power five-cylinder drilling pump system comprises: a drilling pump group, a frequency conversion control room and a pump health system; wherein:
the drilling pump set comprises a base, and the base is provided with a transmission assembly, a power end assembly, a hydraulic end assembly and a lubrication system;
the frequency conversion control room is used to provide frequency-changing AC power for the transmission assembly, and realize the control and protection of the drilling pump group; and
the pump health system comprises a power end health diagnosis system and a liquid power end health diagnosis system.

Further, the power end health diagnosis system comprises a winding temperature sensor installed on the main motor of the drilling pump set, a motor bearing temperature sensor mounted on the motor bearing, and a crankshaft main bearing temperature sensor used on the crankshaft in the drilling pump to detect the temperature of the crankshaft main bearing.

Further, the power end health diagnosis system also comprises a temperature sensor for detecting the internal temperature of the oil tank of the lubrication system, a temperature sensor for detecting the temperature of the main oil circuit of the lubrication system, and an oil pressure sensor for detecting the pressure of the main oil circuit of the lubrication system sensor.

Further, the data detected by the sensor is transmitted to the frequency conversion control room through the cable, and when the specified value is reached, the drilling pump group can be protected by alarm or shutdown.

Further, the hydraulic end health diagnosis system comprises an HMI module, a control module and sensors set on site;

The HMI module has the functions of fast reading, storing sampled data, periodic automatic filing, and automatic deletion after expiration.

Further, the liquid end health diagnosis system comprises a plurality of strain gauge sensors, a plurality of pressure sensors, a plurality of speed sensors, proximity switches and decoders;

The strain gauge sensor is arranged on a surface of the hydraulic end assembly to measure the stress of each fluid cylinder;

The pressure sensors are respectively arranged on the suction chamber of the hydraulic end assembly and the discharge five-way pressure gauge seat for testing the pressure of the liquid;

The speed sensor is installed on the suction chamber of the hydraulic end assembly, and is used to measure the vibration data of the hydraulic end suction cylinder;

The proximity switch and the encoder are used to measure the motion trajectory of each piston mechanism, and the two cooperate to obtain real-time values from the encoder, and the proximity switch zeroes the encoder.

Further, there are 5 strain gauge sensors, which are respectively assembled on the surface of the hydraulic end assembly, and are used to measure the pressure of each hydraulic cylinder respectively.

Further, there are 6 pressure sensors, 5 of which are installed on the suction chamber of the hydraulic end assembly, and 1 of the pressure sensors is installed on the discharge five-way pressure gauge seat.

Further, there are 5 speed sensors, and the speed sensors are piezoelectric speed sensors, which are assembled on the suction cavity of the hydraulic end assembly and used to measure the vibration data of the suction cavity of the hydraulic end assembly.

Further, the drilling pump set comprises a base on which a drilling pump and a lubrication system are arranged, the drilling pump comprises a transmission assembly, a power end assembly and a hydraulic end assembly, and the lubrication system a power end lubrication system for lubrication and cooling of transmission assembly and power end assembly, hydraulic end lubrication system for lubrication and cooling of hydraulic end assembly;

The power end lubrication system comprises a skid, on which a lubricating oil pump is arranged, and a filter used for filtering lubricating oil and communicated with the lubricating oil pump, the filter communicates with the drilling pump, and communicates with a filter for lubricating oil Cooling cooler, the filter is provided with a temperature control switch, through which the lubricating oil is controlled to come out of the filter and then enter the drilling pump for lubrication and cooling or enter the cooler for cooling.

Further, the power end lubrication system adopts air cooling or water cooling.

Further, the lubricating system at the power end comprises a lubricating oil suction nozzle and an oil discharge nozzle, the lubricating oil pump is provided with an oil pump inlet and an oil pump outlet, the suction nozzle communicates with the oil pump inlet, the oil discharge pipe port is connected to the drilling pump;

The filter is provided with a filter oil inlet, and the filter oil inlet is connected to the oil pump outlet, and the filter is also provided with a filter oil discharge port 1 and a filter oil discharge port 2, and the filter oil discharge port 1 is connected to the cooler for lubricating oil cooling, and the filter oil discharge port 2 is connected to the oil discharge pipe port for sending the lubricating oil into the drilling pump.

Further, the cooler is provided with a cooler oil inlet and a cooler oil outlet, the cooler oil inlet is connected to the filter oil outlet 1, and the cooler oil outlet is connected to the oil outlet pipe to achieve the cooled lubricating fluid entering the drilling pump.

Further, the lubrication system at the power end is also provided with an oil overflow pipeline, and the oil overflow pipeline is connected to the oil pipeline of the system through the overflow safety valve group, and the oil pressure is detected through the overflow safety valve group to control the overflow of lubricating oil.

Further, the cooler comprises a power module, a heat exchange module and a water curtain module, and the power module adopts air suction to achieve cooling, and the power module comprises a motor and cooling fan blades arranged on the rotor of the motor.

Further, the water curtain module comprises a housing, a heat dissipation water curtain wall, a water inlet pipe, a water outlet and a pool, the housing is provided with a cooling water inlet, and is connected to a water source through the water inlet pipe, and also comprises a water diversion device, through the water distribution device to evenly enter the water into the upper part of the cooling water curtain wall.

Further, the transmission assembly comprises a motor module, a transmission mechanism and a crank linkage mechanism, the motor module is connected to and assembled with the crank linkage mechanism through the transmission mechanism, and the movement of the crank linkage mechanism is realized through the motor module;

The power end assembly comprises a plurality of power units, each of which is assembled and connected to the crank linkage mechanism, and the other end is independently equipped with a piston mechanism of the hydraulic end assembly, through which the power end assembly In order to realize the driving of the hydraulic end assembly.

Further, the transmission assembly comprises a frame on which a motor module is arranged, the transmission mechanism comprises a driving wheel arranged on the motor module, and a driven wheel for driving the crank linkage mechanism, the crank mechanism comprises a crankshaft provided with a driven wheel, on which a plurality of support bearings and a plurality of connecting rods are assembled.

Further, the two sides of the frame are provided with driving wheels, and the two ends of the crankshaft are provided with driven wheels, and the motor module controls two driving wheels to rotate synchronously, and the driving wheels cooperate with the driven wheels to realize crankshaft rotation.

Further, the two sides of the motor module are provided with rotating shafts, and the two ends of the rotating shaft are fixedly equipped with driving wheels, and the driving wheels are fixedly assembled on the rotating shaft, so as to realize synchronously rotating between the driving wheel and the rotating shaft.

Further, the driving wheel is assembled on the rotating shaft through an interference fit;

The driving wheel has a tapered inner hole, and the end of the rotating shaft is a tapered column, and the assembly of the tapered inner hole and the tapered column is realized through interference fit, so as to facilitate the disassembly of the driving wheel; or, the driving wheel has a cylindrical inner hole, and the end of the rotating shaft is a circular column, and the assembly of the cylindrical inner hole and the circular column is realized through interference fit.

Further, the rotating shaft is an integral structure, or the rotating shaft is a split structure, and realizes synchronous rotation under the action of the motor module.

Further, the crankshaft has a plurality of crank throws, the crankshaft is fixedly mounted on the frame through a plurality of support bearings, the crank throws are located between two adjacent support bearings, and the crank throws are assembled with connecting rods.

Further, there are 6 support bearings, and 5 crank throws.

Further, the driving wheel and the driven wheel adopt helical or straight tooth meshing to realize the transmission; the diameter of the driving wheel is smaller than that of the driven wheel to achieve the deceleration effect.

Further, the motor module is a top-mounted type, and the motor module is a permanent magnet integrated motor or a three-phase squirrel-cage asynchronous motor.

Further, the power end assembly comprises a crosshead box, the crosshead box is provided with a plurality of crosshead chambers for assembling the crosshead structure, and the crank linkage mechanism is provided with a plurality of connecting rods, each connecting rod is connected and assembled with the corresponding crosshead structure, and under the force of the connecting rod, the crosshead structure can realize linear reciprocating motion.

Further, the crosshead box is also provided with a box cover for covering the crosshead chamber;

The box cover plate is an integral structure; or, the box cover plate is a split structure, the box cover plate comprises a plurality of cover plate units, each of the crosshead chambers is provided with a cover Board unit, so as to improve the efficiency of equipment maintenance.

Further, the front end of the crosshead box is provided with a crankcase for assembling the crank linkage mechanism, a motor seat is provided above the crankcase, and bearing seats for assembling the motor shaft are provided on both sides of the motor seat. The end of the crosshead box for assembling the hydraulic end assembly is provided with a cylinder chamber, and the end of the cylinder chamber is provided with a front wall plate for connecting the hydraulic end assembly.

Further, the hydraulic end assembly comprises a liquid suction module, a liquid discharge module, and a piston mechanism connected to the power end assembly, and the movement of the piston mechanism controls the suction and discharge of liquid;

In the state where the piston mechanism is contracted, the liquid suction module sucks liquid;

In a state where the piston mechanism is advanced, the liquid discharge module discharges liquid.

Further, the hydraulic end assembly comprises a liquid end frame, and the piston mechanism comprises a piston cylinder assembled on the liquid end frame, a piston rod located inside the piston cylinder, and a piston rod disposed at the end of the piston rod. The piston head, the other end of the piston rod is assembled with the power end assembly to realize the operation of the piston mechanism.

Further, the end of the power end assembly for assembling the hydraulic end assembly is provided with a cylinder chamber, and the end of the cylinder chamber is provided with a front wall plate for connecting the hydraulic end assembly; The piston mechanism can be assembled in the cylinder chamber to facilitate the assembly of the piston mechanism and the power end assembly; the liquid end frame is assembled with the front wall plate through bolts to realize the assembly of the overall device.

Further, the piston cylinder is assembled on the liquid end frame through a plurality of cylinder liner bolts, and a pressure plate is also arranged on the piston cylinder, and the cylinder liner bolts pass through the pressure plate and are connected to the liquid end frame.

Further, the front end of the pressure plate is provided with a gland locking disc, and the gland locking disc is positioned through a cylinder nut, and a cylinder nut is provided at the rear end of the gland locking disc for contact with the pressure plate. Fitting to achieve positioning, a cylinder nut is provided at the front end of the gland shrink disk to realize that the gland shrink disk is located between the two cylinder nuts.

Further, the rear end of the pressure plate is provided with a cylinder liner withdrawing mechanism, the cylinder liner withdrawing mechanism comprises a positioning pin fixed on the outside of the piston cylinder, and a cylinder liner withdrawing mechanism, the cylinder liner withdrawing can move along the cylinder The sleeve bolt moves axially, and a cylinder nut is also provided at the end of the cylinder liner, and a limit block is arranged on the piston cylinder, and the front end of the cylinder liner nut is fitted with the limit block. Cylinder liner back plate is fixedly connected and assembled with positioning pin shaft.

When disassembling the cylinder liner, the cylinder liner nut at the front end of the pressure plate is withdrawn for a certain distance or after being disassembled, the cylinder liner nut at the rear end of the cylinder liner is withdrawn to realize the withdrawal of the piston cylinder.

The efficient five-cylinder drilling pump system according to claim 30, wherein: the liquid suction module comprises a suction nozzle, a valve assembly and a suction chamber, so as to control the opening/closing of the valve assembly of the discharge module to control the liquid injection from the suction nozzle under the action of the piston mechanism;
the liquid discharge module comprises a discharge nozzle, a valve assembly, and a discharge cavity; the suction cavity communicates with the discharge cavity; under the action of the piston mechanism, the opening/closing of the valve assembly of the discharge module is controlled to control the liquid discharge nozzle.

Further, the base is also provided with a hoisting frame mechanism, and the hoisting frame is also provided with a small block, and the small block can slide on the hoisting rack.

A solids control system comprises the above-mentioned high-power five-cylinder drilling pump system.

A drilling rig comprises the above-mentioned high-power five-cylinder drilling pump system.

In summary, owing to adopting above-mentioned technical scheme, the beneficial effect of the present invention is:

1. A high-power five-cylinder drilling pump system, solids control system and drilling rig of the present invention can monitor the pumping equipment in real time, use electronic monitoring to track pump performance parameters in real time, display the health status of the pump in real time, and provide predictive pump inspection instructions, reduce unpredicted downtime of equipment, improve equipment stability and reduce overall maintenance costs.

2. A high-power five-cylinder drilling pump system, solids control system and drilling rig of the present invention have internal logic protection and safety interlock functions, and a control system with automatic alarm and shutdown protection functions to ensure equipment and personal safety.

3. A high-power five-cylinder drilling pump system, solids control system and drilling rig of the present invention establish a remote expert online diagnosis system. Through the big data platform, real-time diagnosis is made on the operating status of the drilling pump at the client, and the bearings, crossheads, and bearings are predicted. The life of key parts such as slides and cylinders, predict the life of cylinder liners, pistons and valve assemblies, and solve major technical problems.

4. The present invention relates to a high-power five-cylinder drilling pump set that realizes a modular design in the design of the entire structure, and can effectively solve the problem of a large structure of the traditional drilling pump or the drilling pump set in terms of the spatial layout of the structure. With the help of the traditional On the basis of structural design, this application solves the problem of complex structure caused by intermediate mechanical variable speed transmission mechanisms such as belt transmission and chain transmission, and effectively realizes the optimization effect of the entire structure.

5. Based on the design of the motor, the structure adopts a single motor overhead direct drive structure. The motor is above the frame, and the pinion is directly heat-packed on both sides of the motor shaft through the cone surface, so that the structure of the drilling pump is simple and the width direction is reduced. The size meets the transportation requirements, and the transmission efficiency is increased by about 3% to 7% through the direct drive of the motor.

6. With the five-cylinder design adopted in the present invention, the discharge flow rate and pressure fluctuation are reduced by 16.5% compared with the three-cylinder drilling pump, and the pressure fluctuation under high pressure is only 2%-3%.

7. In the design of the lubricating and cooling system at the power end, a specially designed water curtain air cooler is adopted. When the ambient temperature is high (greater than 35° C.), the water curtain module can quickly evaporate water to make the water entering the cooler The air temperature is lowered by about 8-10° C., which can effectively improve the heat transfer efficiency of the cooler in high-temperature environments, and ensure that the lubrication system at the power end can effectively control the lubricating oil temperature in high-temperature environments, thereby ensuring the reliability of the lubrication system. Water cooling is achieved by using a compressor. The refrigeration equipment cools the cooling water, and then cools the power end lubrication system through the cooling water, which can ensure the reliability of the drilling pump in a high temperature environment above 55° C.

8. The pump health system can monitor the pumping equipment in real time, use electronic monitoring to track pump performance parameters in real time, display the health status of the pump in real time, provide predictive pump inspection instructions, reduce unpredicted shutdown of equipment, improve equipment stability and reduce overall maintenance costs.

9. Establish a remote expert online diagnosis system, and use the big data platform to conduct real-time diagnosis of the operating status of the client's drilling pump, predict the life of key components such as bearings, crossheads, slides, and hydraulic cylinders, and predict the total life of cylinder liners, pistons, and valves. To achieve a long life, to solve major technical problems

### BRIEF DESCRIPTION OF THE DRAWINGS

The invention will be illustrated by way of example with reference to the accompanying drawings, in which:

FIG. 1a is a schematic diagram of a structure of the present invention.

FIG. 1b is a schematic flowchart of the diagnostic system of the present invention.

FIG. 2 is a structural schematic diagram of the top view of the present invention.

FIG. 3 is a schematic diagram of the assembled structure of the decoder of the present invention.

FIG. 4 is a first schematic diagrams of the assembly structure of the liquid end health diagnosis system of the present invention.

FIG. 5 is a second schematic diagram of the assembly structure of the hydraulic end health diagnosis system of the present invention.

FIG. 6 is a schematic structural diagram of the present invention.

FIG. 7 is a structural schematic diagram of the top view of the present invention.

FIG. 8 is a schematic structural diagram of the power end lubrication system of the present invention.

FIG. 9 is a top view of the power end lubrication system of the present invention.

FIG. 10 is a side view of the power end lubrication system of the present invention.

FIG. 11 is a schematic diagram of the structure and composition of the water curtain cooler of the present invention.

FIG. 12 is a schematic diagram of the structure and composition of the water curtain module of the water curtain cooler of the present invention.

FIG. 13 is a structural representation of the AC variable frequency drilling pump of the present invention.

FIG. 14 is a structural representation of the front view of the AC variable frequency drilling pump of the present invention.

FIG. 15 is a structural schematic diagram of the top view of the AC variable frequency drilling pump of the present invention.

FIG. 16 is a structural schematic diagram of the transmission assembly of the AC variable frequency drilling pump of the present invention.

FIG. 17 is a structural schematic diagram of the driving wheel assembly of the AC variable frequency drilling pump of the present invention.

FIG. 18 is a schematic diagram of an enlarged structure at B in FIG. 5.

FIG. 19 is a structural schematic diagram of the front view of the permanent magnet variable frequency drilling pump of the present invention.

FIG. 20 is a structural schematic diagram of a top view of the permanent magnet variable frequency drilling pump of the present invention.

FIG. 21 is a schematic structural view of the transmission assembly of the permanent magnet variable frequency drilling pump of the present invention.

FIG. 22 is a structural schematic diagram of the drive wheel assembly of the permanent magnet variable frequency drilling pump of the present invention.

FIG. 23 is a schematic diagram of an enlarged structure at point A in FIG. 10.

FIG. 24 is a schematic structural view of the box body of the present invention.

FIG. 25 is a schematic structural view of the power end assembly of the present invention.

FIG. 26 is a schematic diagram of the assembly of the crosshead structure of the present invention.

FIG. 27 is a schematic structural view of the hydraulic end assembly of the present invention.

Reference numbers of elements in the Figs: 1—transmission assembly, 11—motor module, 12—driving wheel, 13—driven wheel, 14—crankshaft, 15—support bearing, 16—connecting rod, 17—rotating shaft, 18—frame, 19—Bearing seat, 110—Crank, 111—Crankcase, 112—Motor seat, 2—Power end assembly, 21—Crosshead box, 22—Crosshead structure, 221—Slide housing, 223—Telescopic rod, 222—cross hinge, 23—crosshead chamber, 24—box cover, 25—cylinder chamber, 26—front wall, 3—hydraulic end assembly, 31—hydraulic end frame, 32—Piston cylinder, 33—piston rod, 34—piston head, 35—bolt, 36—liner bolt, 37—pressure plate, 38—gland locking disc, 39—liner nut, 310—locating pin, 311—cylinder Set back plate, 312—suction nozzle, 313—valve assembly, 314—suction cavity, 315—discharge nozzle, 316—discharge cavity, 317—end flange resistance, 318—limit block, 319—Wear-resistant plate, 320—discharge five-way pressure gauge seat, 4—base, 5—power end lubrication system, 51—skid seat, 52—lubricating oil pump, 521—oil pump inlet, 522—oil pump outlet, 53—Filter, 531—filter oil inlet, 532—filter oil outlet one, 533—filter oil outlet two, 54—cooler, 541—cooler oil inlet, 542—cooler oil outlet, 543—motor, 544—radiating blade, 55—temperature control switch, 56—liquid inlet nozzle, 57—oil discharge nozzle, 58—oil overflow pipeline, 6—hydraulic end lubrication system, 7—water curtain module, 71—Housing, 711—cooling water inlet, 72—radiation water curtain wall, 73—inlet water pipe, 74—water outlet, 75—reservoir pool, 8—heat exchange module, 9—hanging frame mechanism, 10—small block, A1—control module, A21—strain gauge sensor, A22—pressure sensor, A23—speed sensor, A24—decoder.

### DETAILED DESCRIPTION OF THE PREFERRED EMBODIMENT

All features disclosed in this specification, or steps in all methods or processes disclosed, may be combined in any manner, except for mutually exclusive features and/or steps.

Any feature disclosed in this specification, unless specifically stated, can be replaced by other alternative features that are equivalent or have similar purposes. That is, unless expressly stated otherwise, each feature is one example only of a series of equivalent or similar features.

### Embodiment 1

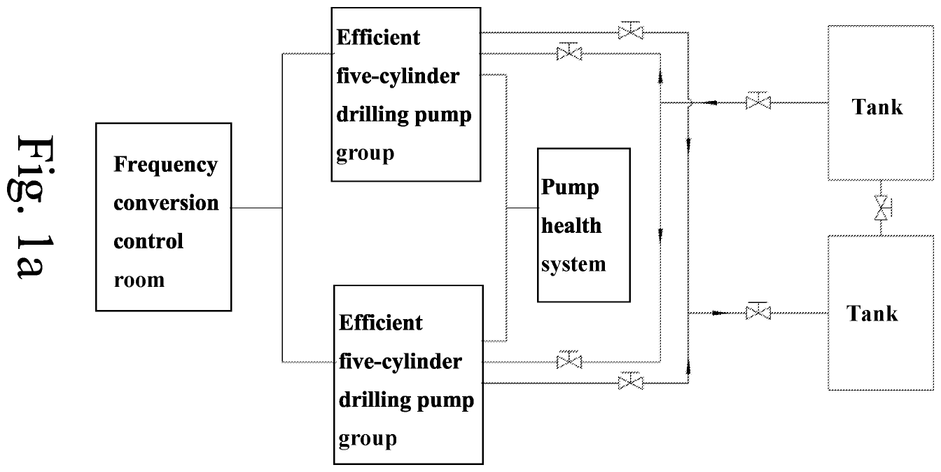

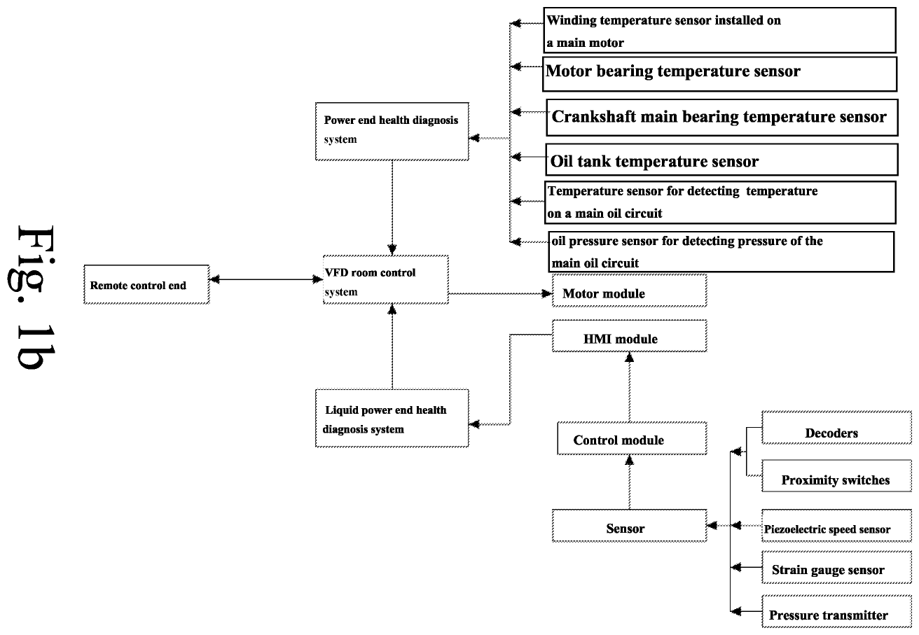

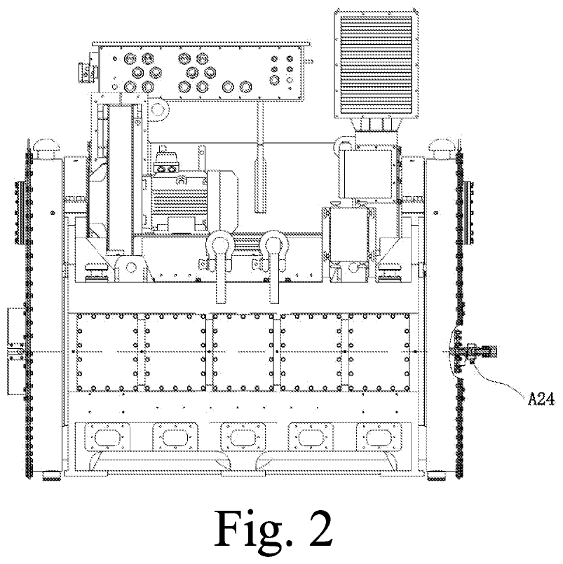

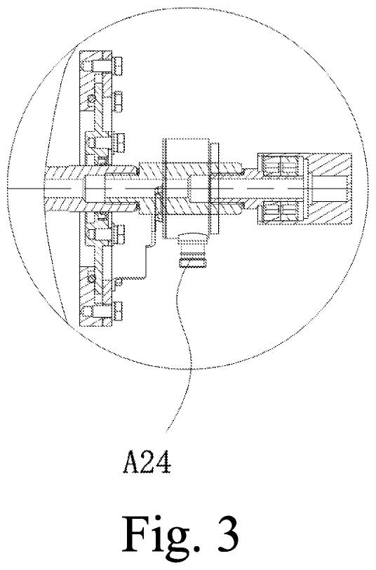

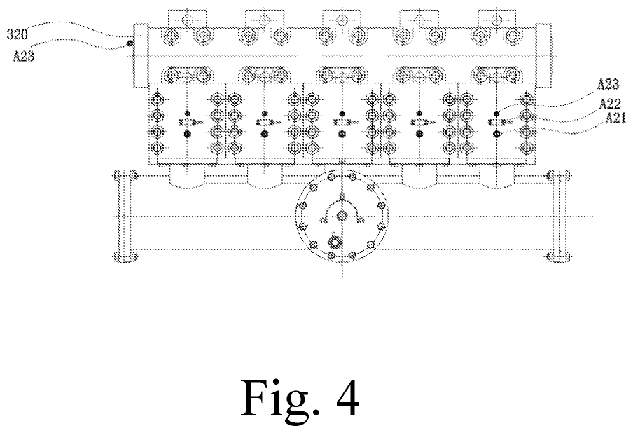

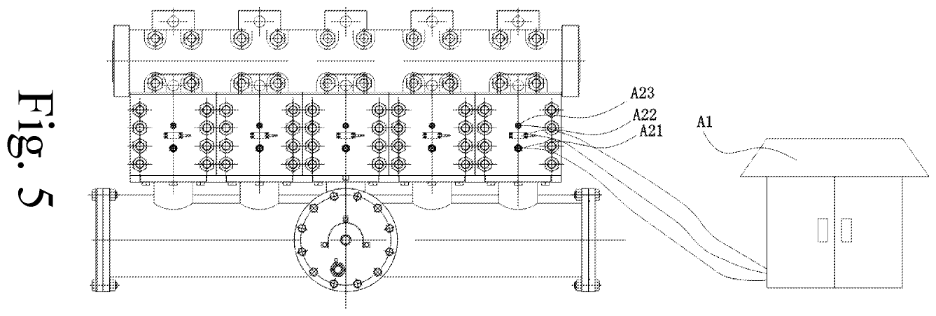

A high-power five-cylinder drilling pump system, as shown in FIGS. 1-5, comprises a drilling pump set, a frequency conversion control room and a pump health system;

The drilling pump set comprises a base 4, and the base is provided with a transmission assembly 1, a power end assembly 2, a hydraulic end assembly 3 and a lubrication system;

The frequency conversion control room is used to provide frequency-changing AC power for the transmission assembly, and realize the control and protection of the drilling pump group;

The pump health system comprises a power end health diagnosis system and a liquid power end health diagnosis system.

In this embodiment, in terms of structural design, the drilling pump set is modularized, and the frequency conversion control room is used to provide frequency conversion, which effectively realizes the simplification of the entire structure, especially in the field of drilling, where the structure needs Realize compactness and simplification to facilitate on-site construction and occupy a small space on site. The pump health system can monitor the pumping equipment in real time, use electronic monitoring to track pump performance parameters in real time, display the health status of the pump in real time, and provide predictive pump inspection. Instructions, reduce unpredicted equipment downtime, improve equipment stability and reduce overall maintenance costs.

Based on the design of the above specific structure, as a specific design, the power end health diagnosis system comprises a winding temperature sensor installed on the main motor of the drilling pump set, a motor bearing temperature sensor mounted on the motor bearing, and a temperature sensor used in the drilling pump. The crankshaft main bearing temperature sensor on the crankshaft is used to detect the temperature of the crankshaft main bearing. In this structure, the operating parameters of the core structure need to be further collected to facilitate the effective detection and maintenance of the entire structure.

Based on the specific structural design above, in a more specific design, the power end health diagnosis system also comprises a temperature sensor for detecting the internal temperature of the oil tank of the lubrication system, a temperature sensor for detecting the temperature of the main oil circuit of the lubrication system, and a temperature sensor for detecting the temperature of the main oil circuit of the lubrication system. An oil pressure sensor that detects the pressure of the main oil circuit of the lubrication system. The design of this structure can more effectively realize the monitoring of the liquid inside the entire structure, and realize precise control and maintenance.

As a more specific design, on the basis of the above-mentioned specific structural design, in the data transmission, the data detected by the sensor is transmitted to the frequency conversion control room through the cable. Protect. The health diagnosis system of the power end can accurately judge and display the health status of the key components of the power end in real time, realize the early prediction of motor and bearing failure, reduce the failure risk of the power end, and improve the reliability of the equipment

On the basis of the design of the above specific structure, a further design is made for the hydraulic end health diagnosis system. Specifically, the hydraulic end health diagnosis system comprises the HMI module, the control module A1 and the sensors installed on site;

The HMI module has the functions of fast reading, storing sampled data, periodic automatic filing, and automatic deletion after expiration.

In the design of the above-mentioned specific structure, the specific description, for the HMI module, compiles the pump health information management interface to realize data display, real-time analysis and historical analysis. Establish data analysis rules and algorithms, and prepare to judge the status of the valve in the cylinder according to the data abnormality: healthy, mild wear, severe wear, and failure.

As a more specific design, the control module adopts a PLC controller. In this embodiment, preferably, Siemens 1500 series PLC is adopted. After preliminary processing, the sampled data is stored in the PLC dedicated data storage block (DB) for communication transfer and read by the host computer as a whole.

On the basis of the design of the above specific structure, as a more specific design, the hydraulic end health diagnosis system comprises multiple strain gauge sensors A21, multiple pressure sensors A22, multiple speed sensors A23, and proximity switches and decoders A24;

The strain gauge sensor A21 is arranged on the surface of the hydraulic end assembly 3 to measure the pressure of each hydraulic cylinder respectively;

The pressure sensor A22 is respectively arranged on the suction cavity 314 of the hydraulic end assembly 3 and the discharge five-way pressure gauge seat 320 for testing the pressure of the liquid;

The speed sensor A23 is mounted on the suction cavity 314 of the hydraulic end assembly 3, and is used to measure the vibration data of the hydraulic end suction cylinder;

The said proximity switch and the encoder A24 are used to measure the motion trajectory of each piston mechanism, and the two cooperate to obtain real-time values by the encoder A24, and the proximity switch zeroes the encoder.

Specifically, the decoder A24 is a crankshaft encoder. Assembled on the hydraulic end assembly 3 through transition joints and swivel joints.

As a specific description, the sensors installed on site detect the pressure, stress, and vibration signals of the mud pump, and at the same time use the frequency conversion torque output, pump body piston position and other information to assist in locating the abnormal cylinder and valve body; according to the experimental results, optimize the selection, Reduce monitoring sensing. in:

The pressure sensor requires A22. The installation position does not affect the assembly and use of the pump body, and it has certain anti-fouling and anti-corrosion capabilities;

The stress sensor A22 needs to consider the installation position to ensure that it can test the stress of the corresponding cylinder;

The proximity switch cooperates with the coded sensor to determine the position of the piston;

The torque information is read to the frequency conversion through the Profibus communication protocol.

Based on the specific design above, the upper computer can realize data collection and storage, calculate and process the data and display the results, and realize comprehensive monitoring of the hydraulic end operation of the five-cylinder drilling pump through the analysis of the operation status information of the high-power five-cylinder drilling pump status, judge the fault point, analyze the cause of the fault, and display the fault information.

### Embodiment 2

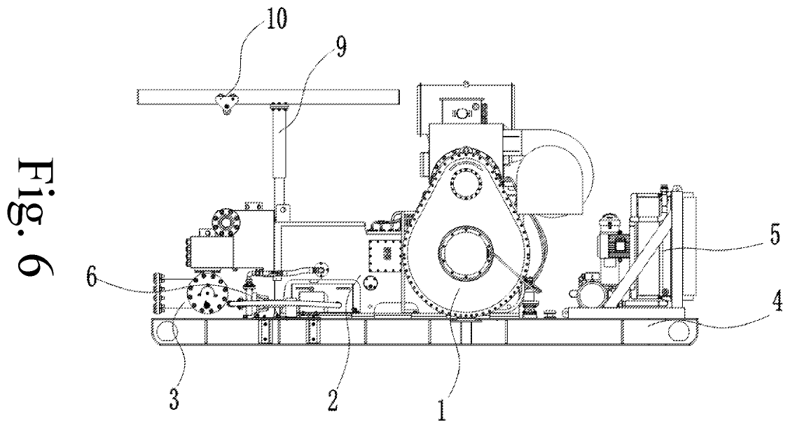

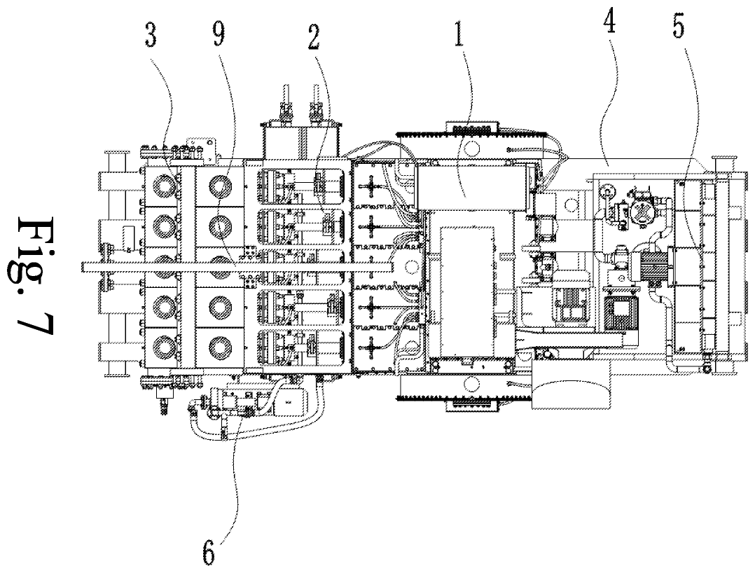

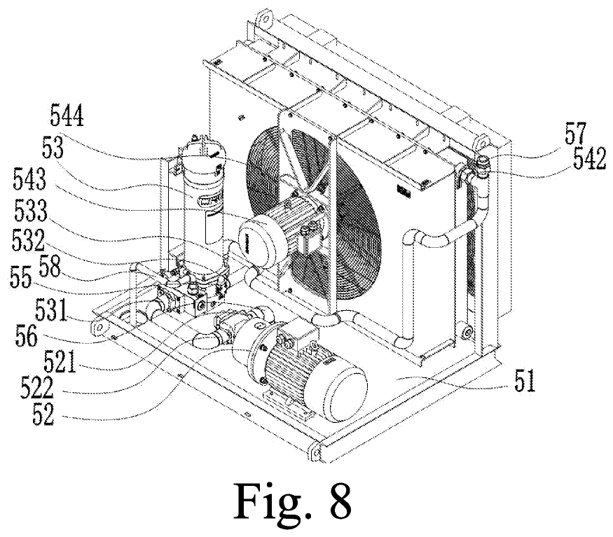

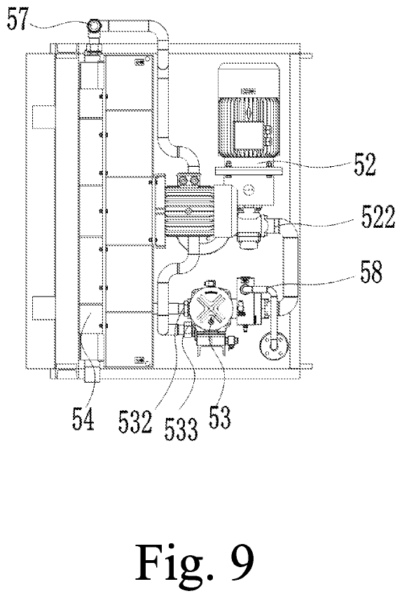

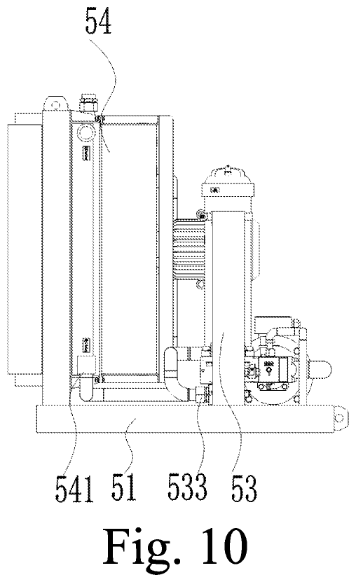

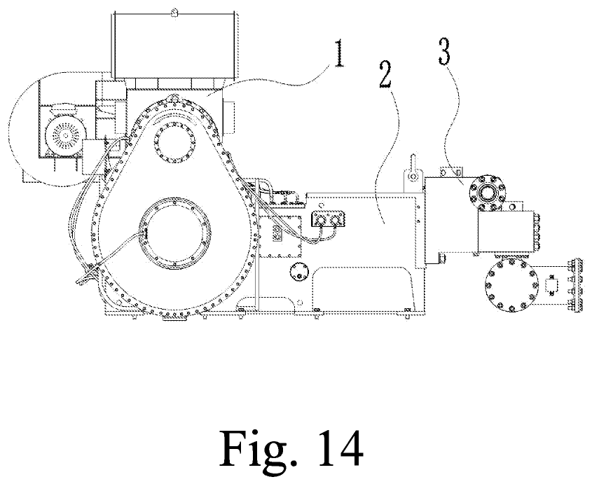

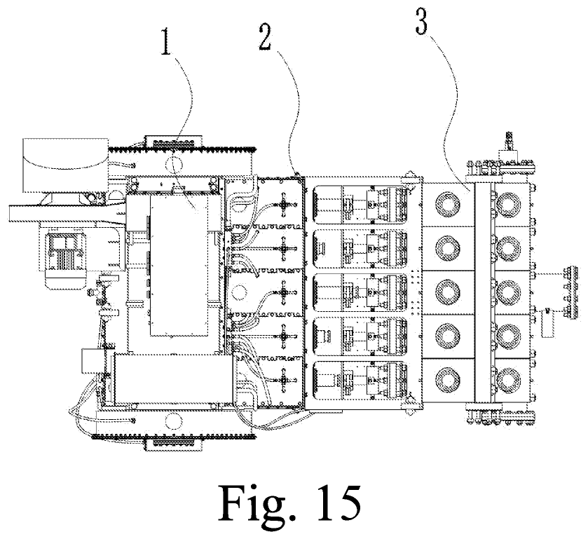

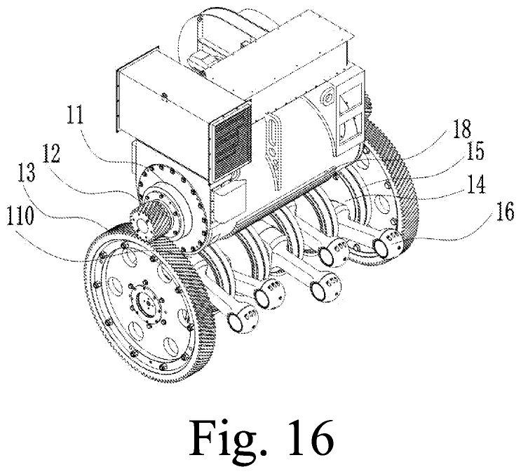

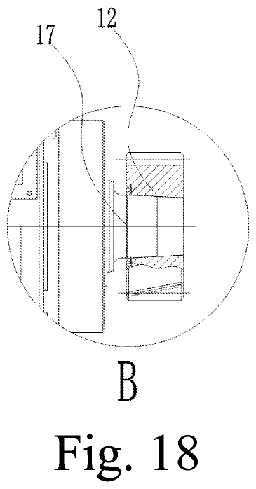

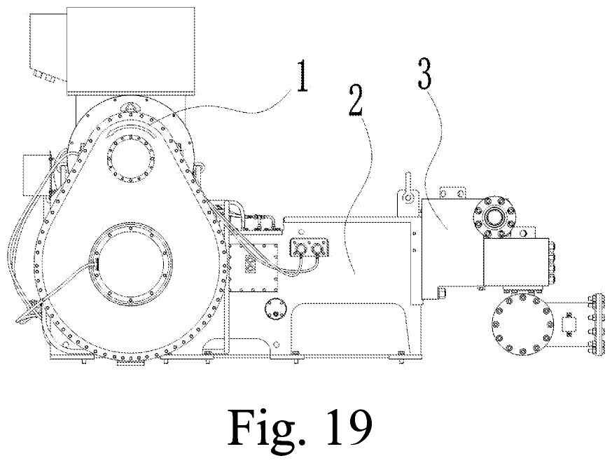

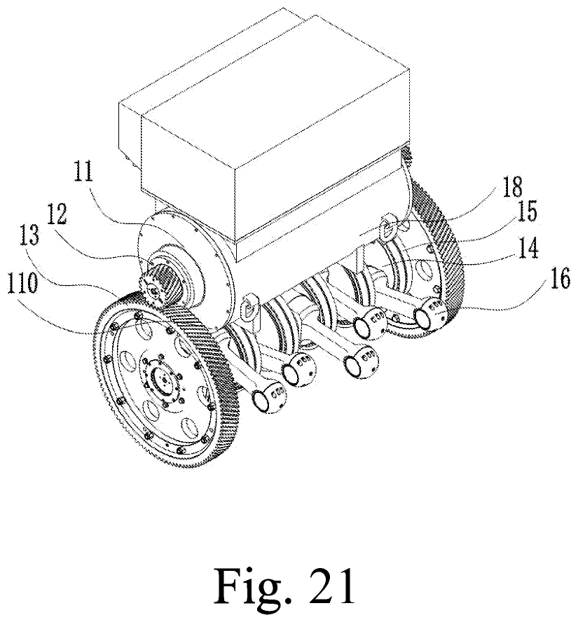

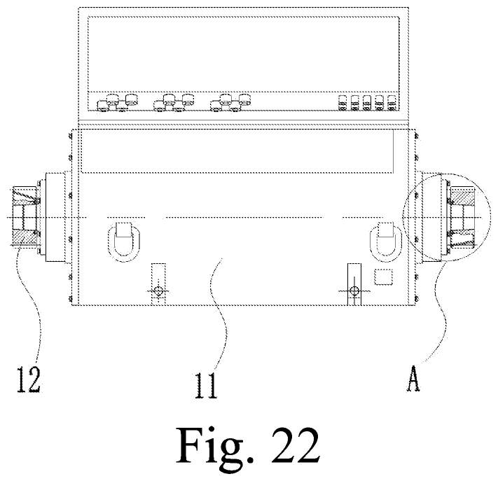

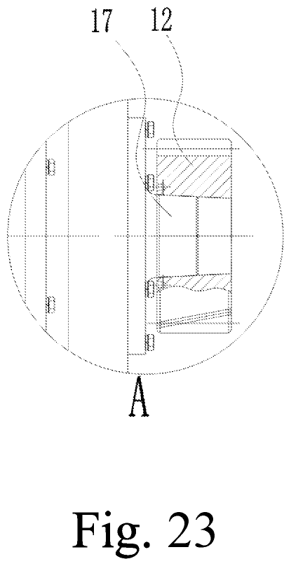

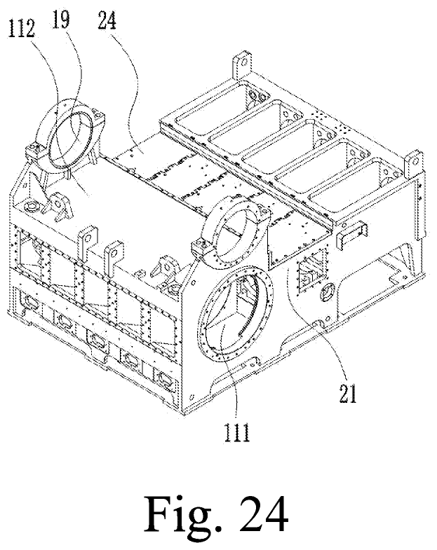

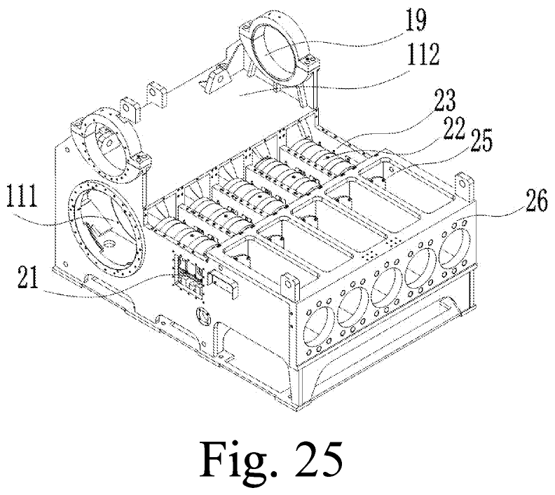

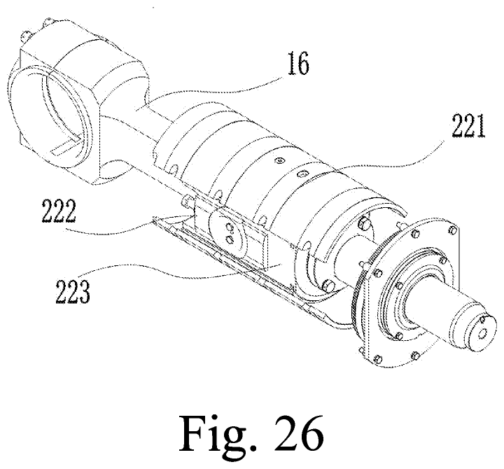

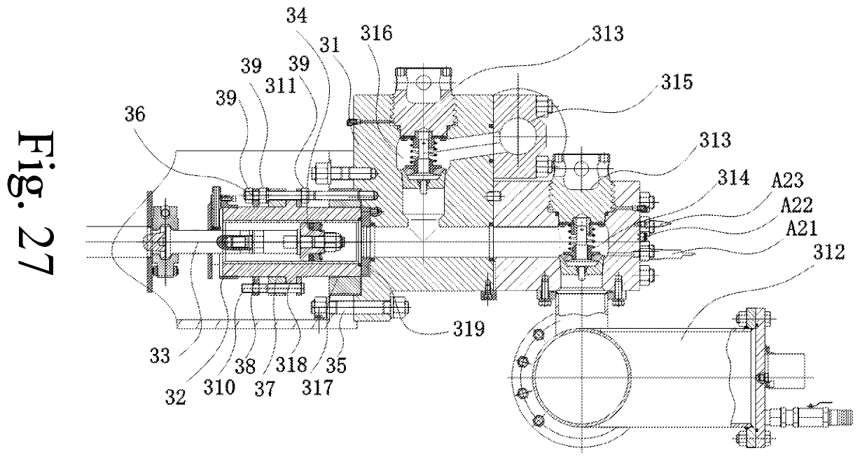

For further design of the drilling pump group, as shown in FIGS. 6 to 27, the drilling pump group comprises a base 4 on which a drilling pump and a lubrication system are arranged, and the drilling pump comprises a transmission assembly 1, a power End assembly 2 and hydraulic end assembly 3, the lubrication system comprises power end lubrication system 5 for lubrication and cooling of transmission assembly 1 and power end assembly 2, used for lubrication and cooling of hydraulic end assembly 3 The hydraulic end lubrication system 6;

The power end lubrication system 5 comprises a skid 51, on which a lubricating oil pump 52 is arranged, and a filter 53 for filtering lubricating oil and communicating with the lubricating oil pump 52, the filter 53 communicates with the drilling pump, And communicated with a cooler 54 for lubricating oil cooling, the filter 53 is provided with a temperature control switch 55, through which the temperature control switch 55 controls the lubricating oil to come out of the filter 53 and then enter the drilling pump for lubrication and cooling or enter cooling in cooler 54.

In this embodiment, based on the design of the drilling pump, the structural design of the cooling system is carried out for the entire drilling pump group. In this design, each unit is designed as an independent and separate design, which can effectively realize the compactness of the entire structure, the effect of simplifying the structure is described as a specific effect. In the field application, the structure is simpler, the floor space is smaller, and the advantages obtained are more obvious than the traditional structure.

Based on the design of the above specific structure, as a more specific design, the power end lubrication system 5 is air-cooled or water-cooled.

As a more specific design of the lubrication system, in a specific embodiment, as a more specific design, the power end lubrication system 5 comprises a suction nozzle 56 and an oil discharge nozzle 57, and the lubricating oil pump 52 is provided with an oil pump inlet 521 and the oil pump outlet 522, the suction nozzle 56 communicates with the oil pump inlet 521, and the oil discharge nozzle 57 communicates with the drilling pump;

The filter 53 is provided with a filter oil inlet 531, and the filter oil inlet 531 communicates with the oil pump outlet 522, and the filter 53 is also provided with a filter oil outlet 532 and a filter oil outlet Two 533, the filter oil discharge port one 532 is connected to the cooler 54 for lubricating oil cooling, and the filter oil discharge port two 533 is connected to the oil discharge pipe port 57 for sending lubricating oil into the drilling pump.

In the design of this structure, its main design purpose is to effectively realize the cooling effect of the lubricating oil. In specific applications, the lubricating oil does not meet the temperature after cooling, and its structure is to keep the lubricating oil cooling. The main function is not only to maintain its lubricating effect, but also the specific cooling effect of the supplier.

On the basis of the design of the above-mentioned specific structure, a further optimization design is carried out for the cooler, the cooler 54 is provided with a cooler oil inlet 541 and a cooler oil outlet 542, and the cooler oil inlet 541 communicates with the filter Oil outlet one 532, the cooler oil outlet 542 communicates with the oil outlet pipe 57 to allow the cooled lubricating fluid to enter the drilling pump. The main purpose of this design is to apply the cooled lubricating oil directly to the lubrication and cooling of the drilling pump.

As a more specific design, the power end lubrication system 5 is also provided with an oil overflow pipeline 58. The oil overflow pipeline 58 is connected to the system oil pipeline through the overflow safety valve group, and the oil leakage is detected through the overflow safety valve group. pressure to control the overflow of lubricating oil.

Based on the design of the above specific structure, as a more specific description, the power end lubrication system and each friction pair are connected through a pipeline system. There are pressure, temperature and other sensors in the pipeline system, and the oil temperature is intelligently detected through the electronic control system, oil pressure and other operating parameters.

In summary, the power end lubrication system provides lubricating oil at a certain pressure for the friction pairs of the power end bearings, gears, crossheads, etc., which plays the role of lubrication and cooling, and can take away the heat generated by the friction pairs through the lubricating oil.

As a more specific design, the new liquid end lubrication system 6 adopts water cooling for cooling and lubrication.

Based on the above-mentioned specific structural design basis, as a more specific design, the base 4 is also provided with a hoisting frame mechanism 9, and the hoisting frame is also provided with a trolley 10, and the trolley can be mounted on the hoisting frame. Swipe up. In the following embodiments, the piston cylinder 32 designed in the hydraulic end assembly 3 will be involved. When it is assembled into the cylinder chamber 25, the structure needs to be modified to realize hoisting.

### Embodiment 3

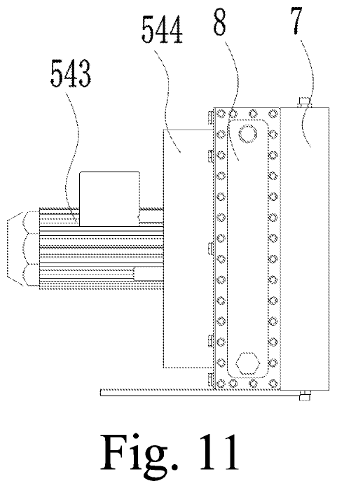

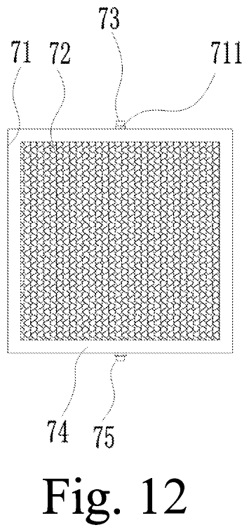

On the basis of the design of Embodiment 2, as a specific description, as shown in FIG. 11 and FIG. 12, on the basis of the above-mentioned specific structural design, as a more specific design, the cooler 54 comprises a power module, a heat exchange module 8 and the water curtain module 7, the power module is cooled by air suction, and the power module comprises a motor 543 and a cooling fan blade 544 arranged on the motor rotor.

In this embodiment, the heat exchange module 8 adopts a mature design, and has a cooling coil with cooling fins inside to increase the heat dissipation area. The power module mainly provides the power of drafting, so that the air can pass through the water curtain module and then pass through the heat exchange module 8, thereby realizing the cooling of the lubricating oil.

As a more specific design, on the basis of the design of the above-mentioned specific structure, the water curtain module is further designed. The water curtain module 7 comprises a housing 71, a heat dissipation water curtain wall 72, a water inlet pipe 73, a water outlet 74 and a pool 75, the housing 71 is provided with a cooling water inlet 711, and is connected to a water source through a water inlet pipe 73, and also comprises a water diversion device, through which water is evenly fed into the top of the cooling water curtain wall.

In this embodiment, its working principle is: after the motor 543 is started, the air enters from the heat dissipation water curtain wall 72 and then passes through the heat exchange tubes of the heat exchange module 8 to take away the heat. When the heat dissipation water curtain wall 72 is connected to the water source, each surface of the water curtain wall is soaked and a water film is formed on the outer surface. When the hot air from the outside passes through the water curtain, the moisture on the surface of the water curtain wall can quickly evaporate and absorb heat, cooling the inlet air. The temperature of the air entering the heat exchange module 8 is greatly reduced, and the temperature difference between the air and the liquid to be cooled is increased, thereby improving the heat exchange efficiency and cooling effect of the cooler. The heat dissipation water curtain wall 72 needs to be kept moist, and the evaporation and water supply are kept in balance, so the required water flow rate is very small. When the ambient temperature is high (greater than 35° C.), the water curtain module 7 can quickly evaporate water to make the water enter the cooling system. The air temperature of the cooler 5 is lowered by about 8-10° C., which can effectively improve the heat exchange efficiency of the cooler in a high temperature environment, and ensure that the power end lubrication system can effectively control the lubricating oil temperature in a high temperature environment, thereby ensuring the reliability of the lubrication system. Water cooling uses compressor refrigeration equipment to cool the cooling water, and then cools the power end lubrication system through the cooling water, which can ensure the reliability of the drilling pump in a high temperature environment above 55° C. At the same time, the water curtain module is only used when the ambient temperature is high (greater than 35° C.) and the lubricating oil temperature cannot be effectively controlled within a low range. It does not need to provide water source for a long time to work, and will not use a large amount of water resources, which can economically and effectively solve the problem of lubrication system at higher temperatures.

### Embodiment 4

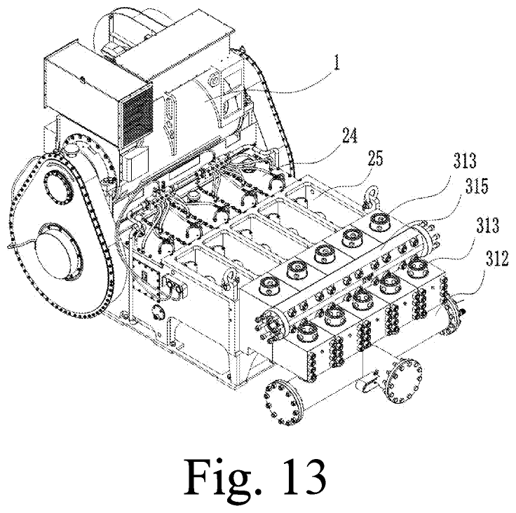

On the basis of the design of Embodiment 2 and Embodiment 3, the design structure of the drilling pump is embodied. As a specific design, as shown in FIGS. 13 to 27, the transmission assembly 1 comprises a motor module 11, a transmission mechanism and a crank connecting rod mechanism, the motor module 11 is connected and assembled with the crank connecting rod mechanism through the transmission mechanism, and movement of the crank connecting rod mechanism is realized through the motor module 11;

The power end assembly 2 comprises a plurality of power units, wherein each of the power units is assembled and connected to the crank linkage mechanism, and the other end is independently equipped with a piston mechanism of the hydraulic end assembly 3, through which the power, the end assembly 2 is used to drive the hydraulic end assembly 3.

In this embodiment, this design uses the drilling pump as a modular design, and adopts a modular design for the transmission assembly 1, the power end assembly 2, and the hydraulic end assembly 3, which can effectively simplify the entire structure, making the entire structure has a better space simplification effect. At the same time, in terms of the maintenance of the entire equipment, this structural design is more convenient for maintenance, and has better effects in terms of work efficiency.

Based on the design of the above-mentioned specific structure, as a further design, specific optimization and design are carried out for the transmission assembly. In another specific embodiment, the transmission assembly 1 comprises a frame 18, on which motor module 11 is provided, the transmission mechanism comprises a driving wheel 12 arranged on the motor module 11, and a driven wheel 13 for driving a crank linkage mechanism; the crank mechanism comprises a crankshaft 14, and the crankshaft is provided with a driven wheel 13. The crankshaft 14 is equipped with a plurality of support bearings 15 and a plurality of connecting rods 16. In this embodiment, the crank connecting rod mechanism is driven by the motor module through the transmission mechanism as the power output part of the whole device.

As a more specific embodiment, on the basis of the design of the above specific structure, as a more specific design, the two sides of the motor module 11 are provided with driving wheels 12, and the two ends of the crankshaft are provided with driven wheels 13. The motor module 11 controls two driving wheels 12 to rotate synchronously, and the driving wheels 12 cooperate with the driven wheels 13 to realize the rotation of the crankshaft 14. In this embodiment, the structural design of directly driving the driven wheel through the driving wheel 12 can effectively solve the structurally complex problems caused by the belt drive and the chain drive. As a more specific description, the design of this structure effectively realizes the modular design of the entire transmission assembly, and can realize the integration of the entire part, which is not only convenient for installation but also convenient for transportation, and reduces parts.

On the basis of the design of the above-mentioned specific structure, as a specific description, a specific design is carried out for the frame 18. The frame 18 comprises a crankcase 111, and the crankcase 111 is assembled with a motor seat 112. Two parts of the motor seat 112, The side is provided with the bearing seat 19 that is used for assembling the rotating shaft of motor. In this structural design, the motor base 112 is used for the design of the motor module. At the same time, at the assembly position, a connecting block for anti-tilting is also provided. After the motor is assembled, it is fixedly assembled with the connecting block. And the structure of the crankcase 111 is applied to the assembly crankshaft connecting structure.

On the basis of the design of the above specific structure, as a more specific design, a rotating shaft 17 is arranged on both sides of the motor module 11, and driving wheels 12 are fixedly mounted on both ends of the rotating shaft 17.

For the assembly of the driving wheel 12 on the rotating shaft 17, as a specific description, in this embodiment, the driving wheel 12 is fixedly assembled on the rotating shaft 17, so as to realize that the driving wheel 12 and the rotating shaft 17 Synchronous rotation adopts a more optimal design, and the driving wheel 12 is assembled on the rotating shaft 17 through an interference fit.

In the interference fit, its specific implementation method has different modes. As a more preferred structure, the driving wheel 12 has a tapered inner hole, and the end of the rotating shaft 17 is a tapered column, and through the interference fit The assembly of the tapered inner hole and the tapered column is realized to facilitate the disassembly of the driving wheel 12. The design of this structure is more convenient for maintenance, and once there is looseness during disassembly, the disassembly of the driving wheel 12 can be effectively realized.

On the basis of the design of the above-mentioned specific structure, as well as the specific design of the rotating shaft, specifically, the rotating shaft 17 is an integral structure, or the rotating shaft is a split structure, and synchronous rotation is realized under the action of the motor module. In the design of this structure, in a more preferred manner, the rotating shaft 17 is an integral structure. That is: the driving wheel 12 is coaxially arranged. In particular, in order to ensure the rotation of the crankshaft 14, even if it is designed as a split structure, that is, the driving wheels 12 are respectively connected to a rotating shaft, the specific requirement is: the rotation of the two driving wheels 12 is synchronous rotation.

On the basis of the design of the above-mentioned specific structure, an in-depth design is carried out for the crank linkage mechanism. More specifically, the crankshaft 14 has a plurality of crank throws 110, and the crankshaft 14 is fixedly assembled on the machine through a plurality of support bearings 15. On the frame 18, the crank throw 110 is located between two adjacent support bearings 15, and the connecting rod 16 is assembled on the crank throw. In the field of the engine, the crank throw 110 is equipped with a small end connecting rod to realize the driving effect, and the big end of the connecting rod 16 is assembled on the crank throw, and the other end is connected to the driven part.

As a more specific design, there are six support bearings 15 and five crank throws 110. In this design, the designed structure is a 5-cylinder structure. The traditional structure is mostly 3-cylinder type, and the difference is based on the whole structure. This structure is simpler and more modular, while the traditional structure is relatively large in equipment and complex in structure, and the design of the cylinder body is also Substantial differences arose.

Specifically designed for the crankcase 111 and the specific crank connecting rod structure, the crankshaft 14 is forged from alloy steel. Described crankshaft 14 is made up of six axle journals and five crank throws 110, and 6 support bearings are installed and fixed on six support bearing blocks. The 6 supporting bearing housings adopt the integral crankshaft bearing housing, and one bearing housing on one side (preferably the leftmost side) adopts a positioning notch design. After the crankshaft 14 is heat-fitted with the inner ring of the bearing and the cage, the whole is hoisted from the selected side. Into the support bearing seat, high installation accuracy, strong reliability. The crankshaft support structure of the five-cylinder drilling pump adopts a 6-point support beam structure. Compared with the two-point support simply supported beam structure of the conventional drilling pump, the bearing force of the main shaft is smaller and the service life is longer, which effectively reduces the maintenance cost of customers.

On the basis of the design of the above-mentioned specific structure, a specific assembly design is carried out for the driving wheel 12 and the driven wheel 13, and its specific structure has the following methods:
1. The driving wheel 12 and the driven wheel 13 are driven by helical gear engagement;
2. The driving wheel 12 and the driven wheel 13 are driven by straight teeth meshing.

As a specific description, in terms of the design of the meshing method, the first method is more preferred, that is, the method of helical tooth meshing is adopted. The design of this structure is more stable, especially in terms of transmission effect, and its service life is also better improved.

As a more specific design, on the basis of gear meshing, as its specific effect, the diameter of the driving wheel 12 is smaller than the diameter of the driven wheel 13 to achieve a deceleration effect.

Based on the design of the above specific structure, as a more specific description, the motor module 11 is a top-mounted type. The structure adopts a single motor overhead direct drive structure, the motor is above the frame, and the driving wheel 12 is directly heat-fitted on both sides of the motor shaft through the tapered surface, so that the structure of the drilling pump is simple, the size in the width direction is reduced, and the transportation requirements are met.

In this embodiment, as a more specific design, as shown in FIGS. 12 to 16, the motor module 11 is a permanent magnet integrated motor.

The integrated design of the motor and the frequency converter cancels the setting of the VFD room, and the permanent magnet motor is directly driven, which has the characteristics of high efficiency, energy saving, low manufacturing cost and transportation cost. The power factor is increased from about 0.83 to 0.95 and above; the rated efficiency is increased from about 0.91 to about 0.968. The current of the permanent magnet motor is smaller, the copper consumption is smaller, and the rated current is reduced by about 350 A under the same power. It has flexible structure, small size and high reliability. The permanent magnet machine relies on permanent magnets, the rotor does not heat up, and only the stator needs to be water-cooled. Compared with the variable frequency asynchronous motor, it can save energy by more than 10%, which greatly reduces the operating cost of customers.

### Embodiment 5

Based on the design of Embodiment 2, the design of the motor is different from Embodiment 2 in that, as shown in FIGS. 6 to 11, the motor module 11 is an AC variable frequency motor. More preferably, the motor module is a three-phase squirrel-cage asynchronous motor.

In this embodiment, the AC variable frequency motor is directly driven, and the transmission efficiency is increased by about 3%-5% compared with the traditional structure; the performance parameters of the AC variable frequency motor are matched to meet the requirements of the drilling pump, and it is manufactured according to the electromechanical fusion design. The motor has long life, high reliability and high stability, and the on-site maintenance is convenient and quick. The motor makes full use of the constant power section to achieve super large displacement output. The maximum displacement of the direct drive drilling pump is 1.2-1.5 times that of the same level drilling pump

### Embodiment 6

On the basis of the design of Embodiment 2, as the assembly between the driving wheel 12 and the rotating shaft 17 is different, this embodiment does not adopt the interference fit method. Specifically, the driving wheel 12 is fixedly assembled on the rotating shaft through a key connection. 17 on.

As a specific description, in this embodiment, its structure can also achieve the effect of disassembly, but during the rotation of the rotor, it is a key as a component subjected to torque force. Although the effect can be achieved, its service life cannot be achieved. Effectively realize the effect of interference fit of the tapered surface.

### Embodiment 7

On the basis of the design of Embodiment 2, the design method of interference fit is also adopted between the driving wheel 12 and the rotating shaft 17. The difference is that, specifically, the driving wheel 12 has a cylindrical inner hole, and the end of the rotating shaft 17 The inner part of the cylinder is a circular column, and the assembly of the cylindrical inner hole and the circular column is realized through interference fit.

In this embodiment, the interference fit effect of the conventional shaft hole and the shaft is used, which can effectively realize the function of relatively balanced force in the specific effect, but it will cause damage to the rotating shaft or the driving wheel during the disassembly process, At the same time, it also prolongs the disassembly time, which is not conducive to the efficiency of maintenance.

### Embodiment 8

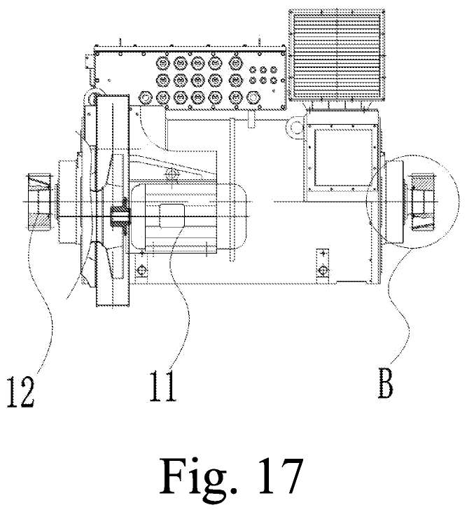

On the basis of the above embodiments, a more specific design is carried out for the power end assembly, as shown in FIGS. 17 to 19, the power end assembly 2 comprises a crosshead box 21, and the crosshead box 21 is set There are a plurality of crosshead chambers 23 for assembling the crosshead structure 22. The crank linkage mechanism is provided with a plurality of connecting rods 16, and each connecting rod 16 is connected and assembled with the corresponding crosshead structure 22. Under the force of 16, the crosshead structure 22 can realize linear reciprocating motion.

In this embodiment, as a specific description, in order to better realize the design of the entire structure, after the crosshead structure 22 is assembled and connected with the connecting rod 16, since the connecting rod 16 is reciprocating, the crosshead structure 22 can be used. Realize that its motion is a linear reciprocating motion, thereby effectively realizing the driving effect.

Based on the design of the above specific structure, as a more specific design, the crosshead box 21 is also provided with a box cover 24 for covering the crosshead chamber 23.

Based on the design of the above-mentioned specific structure and consideration of its use environment, in the specific structure, the crosshead box 21 is also provided with a box cover 24 for covering the crosshead chamber 23.

In this embodiment, as a conventional application, the box cover 24 is used as a specific description, and the box cover 24 is an integral structure.

On the basis of the design of the connection structure, as a more specific description and detailed description, the front end of the crosshead box 21 is provided with a crankcase 111 for assembling the crank linkage mechanism, and a motor seat is provided above the crankcase 111 112, the two sides of the motor base 112 are provided with bearing housings 19 for assembling the motor shaft, and the end of the crosshead box 21 for assembling the hydraulic end assembly 3 is provided with a cylinder chamber 25, the cylinder chamber The end of 25 is provided with a front wall plate 26 for connecting the hydraulic end assembly 3. Specifically, in the design of the entire structure, the structure is that the entire power end assembly 2 is formed into an integral module. After fixed assembly between modules, it effectively realizes the compactness of the entire structure, and So that the drilling pump can better reduce the volume.

### Embodiment 9

On the basis of the design of embodiment 6, as a more specific design, the structural design of the box cover plate is different from the design of embodiment 6. As a specific description, the box body cover plate 24 is a split structure, so The box cover comprises a plurality of cover units, each of the crosshead chambers is provided with a cover unit, so as to improve the efficiency of equipment maintenance.

In this embodiment, the conventional drilling pump has an integral cover plate structure, and the crosshead structure 22 can only be disassembled from the side opening. If the crosshead structure 22 of the middle cylinder is removed, the crosshead structure 22 of the cylinders on both sides must be disassembled. A comparative test in the assembly workshop found that, for the same disassembly and installation of an intermediate cylinder crosshead structure 22, it takes 10 hours for 3 workers for a conventional drilling pump, but it takes 3 hours for 2 workers for a five-cylinder drilling pump in this design. This independent top-opening crosshead cabinet greatly shortens the maintenance time for customers. As a more specific structural design, the crosshead structure 22 comprises a slideway housing 221 forming a slideway, and a telescopic rod 223 is arranged inside the slideway housing 221, and the telescopic rod 223 is used to connect the connecting rod 16. The end is hinged with the connecting rod 16 through a cross hinge 222 to realize the change of the moving direction.

### Embodiment 10

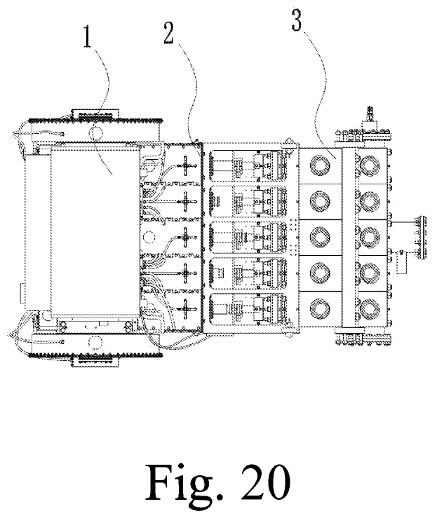

On the basis of the design of the above embodiments, a specific design is made for the design of the hydraulic end assembly, as shown in FIG. 20, the hydraulic end assembly 3 comprises a liquid suction module, a liquid discharge module and a connecting power end assembly The piston mechanism controls the suction and discharge of liquid through the movement of the piston mechanism;

In the state where the piston mechanism is contracted, the liquid suction module sucks liquid;

In a state where the piston mechanism is advanced, the liquid discharge module discharges liquid.

In the design of the structure, as the design of the hydraulic end assembly, through the reciprocating movement of the piston mechanism, the design based on the suction module and the discharge module can effectively realize the entry and discharge of liquid. As a special illustration, the structure can effectively complete the circulation of drilling fluid throughout the structure. At the same time, the entire structure also needs to be modularized.

Specifically, on the basis of the design of the above-mentioned specific structure, in one specific embodiment, the hydraulic end assembly 3 comprises a hydraulic end frame 31, and the piston mechanism comprises a piston cylinder 32, the piston rod 33 inside the piston cylinder 32 and the piston head 34 arranged at the end of the piston rod, the other end of the piston rod 33 is assembled with the power end assembly 2 to realize the operation of the piston mechanism. In the design of this structure, it is not necessary to consider the assembly of the structure with the front-end device, but also the assembly of its own structure, especially in the modular design of the structure. Of course, its main purpose is also to better realize Simplified and compact structure. As a more specific design, the piston rod 33 is connected to the crosshead structure through a clamp.

As a more specific design, based on the design of the above-mentioned specific embodiment, the end of the power end assembly 2 for assembling the hydraulic end assembly is provided with a cylinder chamber 25, and the end of the cylinder chamber 25 A front wall plate 26 is provided for connecting the hydraulic end assembly 3.

As a more specific structural design, the piston mechanism can be assembled in the cylinder chamber 25 to facilitate the assembly of the piston mechanism and the power end assembly 2.

Based on the design of the above specific structure, the liquid end frame 31 is assembled with the front wall plate through bolts 35 to realize the assembly of the whole device. In the design of this structure, the bolts 35 are stud bolts. Both ends are tightened by nuts.

In terms of structural design, in order to realize that the piston cylinder is assembled on the end of the liquid end frame, as a specific description, the piston cylinder 32 is assembled on the liquid end frame 31 through a plurality of cylinder liner bolts 36. A pressing plate 37 is also arranged on the piston cylinder 32, and the cylinder liner bolt 36 passes through the pressing plate 37 and is combined on the hydraulic end frame 31. During the action, an end flange 317 is provided at the end of the piston cylinder 32, the cylinder liner bolt 36 is a stud bolt, the piston cylinder 32 is provided with a limit block 318, and the pressure plate 37 is assembled on the limit The position block 318 is attached to the limit block 318, and the cylinder liner bolt 36 passes through the pressure plate 37 and the limit block 318 and then is threaded through the end flange 317 and assembled on the liquid end frame 31. The front end portion of the pressing plate 37 is closed by a cylinder nut 39.

Based on the design of the above-mentioned specific structure, in order to ensure the assembly effect, specifically, the front end of the pressure plate 37 is provided with a gland locking disk 38, and the gland locking disk 38 is positioned by the cylinder nut 39. The rear end of the gland locking disc 38 is provided with a cylinder nut 39 for fitting with the pressure plate 37 to realize positioning, and the front end of the gland locking disc 38 is provided with a cylinder nut 39 to realize the sealing of the gland locking disc 38. Located between two cylinder nuts 39. In this manner, the assembly effect of the entire device can be further ensured.

As a more specific design, in order to facilitate disassembly and assembly, the rear end of the pressure plate 37 is provided with a cylinder liner withdrawal mechanism. The cylinder liner withdrawal mechanism comprises a positioning pin 310 fixed on the outside of the piston cylinder 32, and a cylinder liner withdrawal mechanism. disc 311, the cylinder liner retreat disc 311 can move axially along the cylinder liner bolt 36, a cylinder liner nut 39 is also arranged at the end of the cylinder liner retreat disc 311, and a limit block 318 is arranged on the piston cylinder 32, the front end of the cylinder liner nut 39 is fit and assembled with the limit block 318, and the cylinder liner back plate 311 is fixedly connected and assembled with the positioning pin shaft 310;

When dismounting the cylinder liner, make the cylinder liner nut 39 at the front end of the pressing plate 37 withdraw from a certain distance or after dismounting, by twisting the cylinder liner nut 39 at the rear end of the disc 311 to realize the withdrawal of the piston cylinder 32.

In this structure, the cylinder liner nut at the front end is disassembled first, and after the cylinder liner nut 39 at the front end of the pressure plate 37 is withdrawn, the cylinder liner nut 39 at the rear end of the cylinder liner withdrawal plate 311 is twisted to push the cylinder liner withdrawal plate to drive the positioning pin The shaft 310 also drives the piston cylinder to retreat outwards, thereby realizing the effect of quick disassembly.

As a more specific design, a wear-resistant plate 319 is also provided between the piston cylinder 32 and the assembly end surface of the liquid end frame 31 to increase the service life of the entire device.

In the specific structural design above, the suction module and discharge module of the hydraulic end assembly 3 are designed, specifically:

The liquid suction module comprises a suction nozzle 312, a valve assembly 313 and a suction cavity 314. Under the action of the piston mechanism, the opening/closing of the control valve assembly controls the liquid entering the suction nozzle.

The liquid discharge module comprises a discharge nozzle 315, a valve assembly 313, and a discharge cavity 316. The suction cavity 316 communicates with the discharge cavity 314. Under the action of the piston mechanism, the opening of the valve assembly 313 of the discharge module is controlled. /Close controls the discharge of liquid from the discharge nozzle.

In the specific structural design above, as a specific description of the action, in the design of the valve assembly 313, it can be seen that there is an elastic part at the design of the valve stem. For better illustration, when the piston withdraws, the valve assembly of the suction module is opened upwards under the action of suction, and the liquid is passed in. At this time, the valve assembly of the discharge module receives a downward force and remains closed; The internal pressure makes the valve assembly of the suction module receive a downward thrust, and the suction module remains closed. At this time, the valve assembly of the discharge module is pushed upward, prompting the valve assembly of the discharge module to open, thereby realizing liquid discharge.

Based on the above embodiments, in order to facilitate the hoisting of the entire drilling pump, the specific structure also comprises lifting lugs for hoisting. Specifically, the direct-drive drilling pump is small in size and light in weight, and is suitable for installation in land pump rooms, offshore drilling platforms, transport trailers, and can be used for hoisting by helicopters.

### Embodiment 11

A solids control system, comprising a high-power five-cylinder drilling pump system described in any single or combination of embodiments 1 to 10.

### Embodiment 12

A drilling rig, comprising a high-power five-cylinder drilling pump system described in any single or combination of embodiments 1 to 10.

The present invention is not limited to the foregoing specific embodiments. The present invention extends to any new feature or any new combination disclosed in this specification, and any new method or process step or any new combination disclosed.

1: An efficient five-cylinder drilling pump system, comprising: a drilling pump group, a frequency conversion control room and a pump health system; wherein:
the drilling pump set comprises a base, and the base is provided with a transmission assembly, a power end assembly, a hydraulic end assembly and a lubrication system;
the frequency conversion control room is used to provide frequency-changing AC power for the transmission assembly, and realize the control and protection of the drilling pump group; and
the pump health system comprises a power end health diagnosis system and a liquid power end health diagnosis system.

2: The efficient five-cylinder drilling pump system according to claim 1, wherein: the power end health diagnosis system comprises a winding temperature sensor installed on the main motor of the drilling pump set, a motor bearing temperature sensor assembled on a motor bearing, and a crankshaft main bearing temperature sensor used on a crankshaft in a drilling pump to detect temperature of the crankshaft main bearing.

3: The efficient five-cylinder drilling pump system according to claim 2, wherein: the health diagnosis system of the power end further comprises a temperature sensor for detecting an internal temperature of an oil tank of the lubrication system, a temperature sensor for detecting temperature on a main oil circuit of the lubrication system; and an oil pressure sensor for detecting a pressure of the main oil circuit of the lubrication system.

4: The efficient five-cylinder drilling pump system according to claim 3, wherein: the data detected by the sensor is transmitted to a frequency conversion control room through cables, and when a specified value is reached, the drilling pump group is activated by alarm or shutdown for protection.

5: The efficient five-cylinder drilling pump system according to claim 1, wherein: the hydraulic end health diagnosis system comprises an HMI module, a control module and sensors installed on site;
wherein the HMI module has the functions of fast reading, storing sampled data, periodic automatic filing, and automatically deleting after expiration.

6: The efficient five-cylinder drilling pump system according to claim 5, wherein: the hydraulic end health diagnosis system comprises multiple strain gauge sensors, multiple pressure sensors, multiple speed sensors and proximity switches and decoders;
the strain gauge sensor is arranged on a surface of the hydraulic end assembly to measure the stress of each fluid cylinder;
the pressure sensors are respectively arranged on the suction chamber of the hydraulic end assembly and the discharge five-way pressure gauge seat for testing the pressure of the liquid;
the speed sensor is installed on the suction chamber of the hydraulic end assembly, and is used to measure the vibration data of the hydraulic end suction cylinder; and
the proximity switch and the encoder are used to measure the motion trajectory of each piston mechanism, and the two cooperate to obtain real-time values from the encoder, and the proximity switch zeroes the encoder.

7: The efficient five-cylinder drilling pump system as claimed in claim 6, wherein there are five strain gauge sensors, which are respectively assembled on the surface of the hydraulic end assembly for measuring the pressure of the cylinder.

8: The efficient five-cylinder drilling pump system as claimed in claim 6, wherein there are 6 pressure sensors, 5 of which are installed on the suction cavity of the hydraulic end assembly, one of the pressure sensors is installed on the discharge five-way pressure gauge seat.

9: The efficient five-cylinder drilling pump system according to claim 6, wherein: there are five speed sensors, and the speed sensors are piezoelectric speed sensors, which are assembled in the hydraulic end assembly used to measure the vibration data of the suction cavity of the hydraulic end assembly.

10: The efficient five-cylinder drilling pump system according to claim 1, wherein: the drilling pump set comprises a base on which a drilling pump and a lubrication system are arranged, and the drilling pump comprises a transmission assembly, power end assembly and hydraulic end assembly, the lubrication system comprises the power end lubrication system for transmission assembly and power end assembly lubrication and cooling, and the hydraulic end assembly for hydraulic end assembly lubrication and cooling end lubrication system;
the power end lubrication system comprises a skid, on which a lubricating oil pump is arranged, and a filter used for filtering lubricating oil and communicated with the lubricating oil pump, the filter communicates with the drilling pump, and communicates with a filter for lubricating oil cooler, the filter is provided with a temperature control switch, through which the lubricating oil is controlled to come out of the filter and then enter the drilling pump for lubrication and cooling or enter the cooler for cooling.

11: The efficient five-cylinder drilling pump system according to claim 10, wherein: the lubricating system at the power end is air-cooled or water-cooled.

12: The efficient five-cylinder drilling pump system according to claim 10, wherein: the lubrication system at the power end comprises a lubricating oil suction nozzle and an oil discharge nozzle, and the lubricating oil pump is provided with an oil pump inlet and the oil pump outlet, the suction nozzle is connected to the oil pump inlet, and the oil discharge pipe is connected to the drilling pump;
the filter is provided with a filter oil inlet, and the filter oil inlet is connected to the oil pump outlet, and the filter is also provided with a filter oil discharge port 1 and a filter oil discharge port 2, and the filter oil discharge port 1 is connected to the cooler for lubricating oil cooling, and the filter oil discharge port 2 is connected to the oil discharge pipe port for sending the lubricating oil into the drilling pump.

13: The efficient five-cylinder drilling pump system according to claim 12, wherein: the cooler is provided with a cooler oil inlet and a cooler oil outlet, the cooler oil inlet is connected to the filter oil outlet 1 of the cooler, and the oil outlet of the cooler is connected to the oil outlet pipe to achieve the cooled lubricating fluid entering the drilling pump.

14: The efficient five-cylinder drilling pump system according to claim 12, wherein: the power end lubrication system is also provided with an oil overflow pipeline, and the oil overflow pipeline is connected through an overflow safety valve group, the oil line of the system detects the oil pressure through the overflow safety valve group to control the overflow of lubricating oil.

15: The efficient five-cylinder drilling pump system according to claim 10, wherein: the cooler comprises a power module, a heat exchange module and a water curtain module, and the power module adopts air suction to realize cooling, the power module comprises a motor and cooling fan blades arranged on the rotor of the motor.

16: The efficient five-cylinder drilling pump system according to claim 15, wherein: the water curtain module comprises a shell, a heat dissipation water curtain wall, a water inlet pipe, a water outlet, a water pool, and the shell; a cooling water inlet is provided on the shell, and the water source is connected through the water inlet pipe, and the water diversion device is also included, and the water is uniformly entered into the upper part of the cooling water curtain wall through the water diversion device.

17: The efficient five-cylinder drilling pump system according to claim 10, wherein: the transmission assembly comprises: a motor module, a transmission mechanism and a crank linkage mechanism, and the motor module is connected to a crank through the transmission mechanism, the connecting rod mechanism realizes the movement of the crank connecting rod mechanism through the motor module;
the power end assembly comprises a plurality of power units, each of which is assembled and connected to the crank linkage mechanism, and the other end is independently equipped with a piston mechanism of the hydraulic end assembly, through which the power end assembly to realize the driving of the hydraulic end assembly.

18: The efficient five-cylinder drilling pump system according to claim 17, wherein: the transmission assembly comprises a frame on which a motor module is arranged, and the transmission mechanism comprises a driving wheel on the module, and the driven wheel for driving the crank linkage mechanism, the crank mechanism comprises a crankshaft, the crankshaft is provided with a driven wheel, and a plurality of supporting bearings and a plurality of connecting rods are assembled on the crankshaft.

19: The efficient five-cylinder drilling pump system according to claim 18, wherein: driving wheels are arranged on both sides of the frame, driven wheels are arranged at both ends of the crankshaft; the motor module controls two driving wheels to rotate synchronously, and the driving wheels cooperate with the driven wheels to realize rotation of the crankshaft.

20: The efficient five-cylinder drilling pump system according to claim 19, wherein: the two sides of the motor module are provided with rotating shafts, and the two ends of the rotating shaft are fixedly equipped with driving wheels, and the driving wheel is fixedly assembled on the rotating shaft, so as to realize the synchronously rotating of the driving wheel and the rotating shaft.

21: The efficient five-cylinder drilling pump system according to claim 20, wherein: the driving wheel is assembled on the rotating shaft through interference fit;
the driving wheel has a tapered inner hole, and the end of the rotating shaft is a tapered column, and the assembly of the tapered inner hole and the tapered column is realized through interference fit, so as to facilitate the disassembly of the driving wheel; or, the driving wheel has a cylindrical inner hole, and the end of the rotating shaft is a circular column, and the assembly of the cylindrical inner hole and the circular column is realized through interference fit.

22: The efficient five-cylinder drilling pump system according to claim 19, wherein: the rotating shaft is an integral structure, or the rotating shaft is a split structure, and the synchronization is realized under the action of the motor module turn.

23: The efficient five-cylinder drilling pump system according to claim 18, wherein: the crankshaft has a plurality of crank throws, and the crankshaft is fixedly assembled on the frame through a plurality of supporting bearings, and the crank throws are located between two adjacent supporting bearings, and connecting rods are assembled on the crank throws.

24: The efficient five-cylinder drilling pump system according to claim 23, wherein: there are 6 support bearings and 5 crank throws.

25: The efficient five-cylinder drilling pump system according to claim 17, wherein: the transmission between the driving wheel and the driven wheel is achieved through helical or straight tooth meshing; the diameter is smaller than that of the driven wheel to achieve the deceleration effect.

26: The efficient five-cylinder drilling pump system according to claim 17, wherein the motor module is a top-mounted type, and the motor module is a permanent magnet integrated motor or an AC variable frequency motor.

27: The efficient five-cylinder drilling pump system according to claim 10, wherein: the power end assembly comprises a crosshead casing, and the crosshead casing is provided with a plurality of structure of the crosshead chamber, the crank linkage mechanism is provided with a plurality of connecting rods, and each connecting rod is connected and assembled with the corresponding crosshead structure, under the pressure of the connecting rod, the crosshead structure can realize a straight line reciprocating motion.

28: The efficient five-cylinder drilling pump system according to claim 27, wherein: the crosshead casing is also provided with a casing cover plate for covering the crosshead chamber;
the box cover plate is an integral structure; or, the box cover plate is a split structure, the box cover plate comprises a plurality of cover plate units, each of the crosshead chambers is provided with a cover Board unit, so as to improve the efficiency of equipment maintenance.

29: The efficient five-cylinder drilling pump system according to claim 27, wherein: the front end of the crosshead casing is provided with a crankcase for assembling the crank linkage mechanism, and above the crankcase is provided with The motor seat, the two sides of the motor seat are provided with bearing seats for assembling the motor shaft, the end of the crosshead box for assembling the hydraulic end assembly is provided with a cylinder chamber, and the end of the cylinder chamber is provided with There is a front wall plate for connecting the hydraulic end assembly.

30: The efficient five-cylinder drilling pump system according to claim 10, wherein: the hydraulic end assembly comprises a liquid suction module, a liquid discharge module and a piston mechanism connected to the power end assembly, through which the piston The movement of the mechanism to control the intake and discharge of fluid;
in the state where the piston mechanism is contracted, the liquid suction module sucks liquid;
in a state where the piston mechanism is advanced, the liquid discharge module discharges liquid.

31: The efficient five-cylinder drilling pump system according to claim 30, wherein: the hydraulic end assembly comprises a liquid end frame, and the piston mechanism comprises a The piston cylinder, the piston rod located inside the piston cylinder and the piston head arranged at the end of the piston rod, the other end of the piston rod is assembled with the power end assembly to realize the operation of the piston mechanism.

32. The efficient five-cylinder drilling pump system according to claim 31, wherein: the end of the power end assembly for assembling the hydraulic end assembly is provided with a cylinder chamber, and the cylinder chamber The end of the chamber is provided with a front wall plate for connecting the hydraulic end assembly; the piston mechanism can be assembled in the cylinder chamber to facilitate the assembly of the piston mechanism and the power end assembly; the hydraulic end frame is connected by bolts Assembled with the front wall panel to achieve the assembly of the whole unit.

33. The efficient five-cylinder drilling pump system according to claim 31, wherein: the piston cylinder is assembled on the hydraulic end frame through a plurality of cylinder liner bolts, and the piston cylinder is also equipped with The pressure plate and cylinder liner bolts pass through the pressure plate and are combined on the liquid end frame.

34. The efficient five-cylinder drilling pump system according to claim 33, wherein: the front end of the pressure plate is provided with a gland locking disk, and the gland locking disk is positioned by the cylinder nut, a cylinder nut is provided at the rear end of the gland shrink disk for fitting with the pressure plate to achieve positioning, and a cylinder nut is provided at the front end of the gland shrink disk to realize that the gland shrink disk is located between the two nuts of cylinders sets.

35: The efficient five-cylinder drilling pump system according to claim 34, wherein: the rear end of the pressure plate is provided with a cylinder liner withdrawal mechanism, and the cylinder liner withdrawal mechanism comprises a cylinder fixed on the outside of the piston cylinder; the positioning pin shaft of the cylinder liner, and the cylinder liner back plate, the cylinder liner back plate can move axially along the cylinder liner bolts, and a cylinder liner nut is also arranged at the end of the cylinder liner back plate, and the piston cylinder is provided with a limited position block, the front end of the cylinder liner nut is attached to the limit block, and the cylinder liner back plate is fixedly connected and assembled with the positioning pin shaft;
when disassembling the cylinder liner, the cylinder liner nut at the front end of the pressure plate is withdrawn for a certain distance or after being disassembled, the cylinder liner nut at the rear end of the cylinder liner is withdrawn to realize the withdrawal of the piston cylinder.

36: The efficient five-cylinder drilling pump system according to claim 30, wherein: the liquid suction module comprises a suction nozzle, a valve assembly and a suction chamber, so as to control the opening/closing of the valve assembly of the discharge module to control the liquid injection from the suction nozzle under the action of the piston mechanism;
the liquid discharge module comprises a discharge nozzle, a valve assembly, and a discharge cavity; the suction cavity communicates with the discharge cavity; under the action of the piston mechanism, the opening/closing of the valve assembly of the discharge module is controlled to control the liquid discharge nozzle.

37. The efficient five-cylinder drilling pump system according to claim 10, wherein: the base is also provided with a hoisting frame mechanism, and the hoisting frame is also provided with a trolley, and the trolley can slide on the pendant rack.

38: A solids control system, comprising the efficient five-cylinder drilling pump system according to claim 1.

39: A drilling rig, comprising the efficient high-power five-cylinder drilling pump system according to claim 1.
